(19) United States
(12) Patent Application Publication
(10) Pub. No.: US 2023/0334321 A1
(43) Pub. Date: Oct. 19, 2023

(54) DEEP NEURAL NETWORK SLIMMING DEVICE AND OPERATING METHOD THEREOF

(71) Applicant: ELECTRONICS AND TELECOMMUNICATIONS RESEARCH INSTITUTE, Daejeon (KR)

(72) Inventors: Su Woong LEE, Daejeon (KR); Jong-Gook KO, Daejeon (KR); Wonyoung YOO, Daejeon (KR); Seungjae LEE, Daejeon (KR); Yongsik LEE, Daejeon (KR); Juwon LEE, Daejeon (KR); Da-Un JUNG, Daejeon (KR)

(73) Assignee: ELECTRONICS AND TELECOMMUNICATIONS RESEARCH INSTITUTE, Daejeon (KR)

(21) Appl. No.: 17/976,655

(22) Filed: Oct. 28, 2022

(30) Foreign Application Priority Data
Apr. 14, 2022 (KR) 10-2022-0046272

(51) Int. Cl. G06N 3/08

(52) U.S. Cl. CPC G06N 3/082; G06N 3/084

(57) ABSTRACT

Disclosed are a deep neural network lightweight device based on batch normalization, and a method thereof. The deep neural network lightweight device based on batch normalization includes a memory that stores at least one data and at least one processor that executes a network lightweight module. When executing the network lightweight module, the processor performs learning on an input neural network based on sparsity regularization to adaptively determine at least one parameter of the sparsity regularization, performs pruning on the learning result, and performs fine tuning on the pruning result.

### CROSS-REFERENCE TO RELATED APPLICATIONS

This application claims priority under 35 U.S.C. § 119 to Korean Patent Application No. 10-2022-0046272 filed on Apr. 14, 2022, in the Korean Intellectual Property Office, the disclosures of which are incorporated by reference herein in their entireties.

### BACKGROUND

Embodiments of the present disclosure described herein relate to a deep neural network lightweight device and an operating method thereof, and more particularly, relate to a deep neural network lightweight device based on batch normalization and sparsity regularization, and an operating method thereof.

Lightweight of a deep neural network is a technology for obtaining a high-accuracy neural network with a small amount of computation, and is required for scenarios such as a mobile, an Internet of Things (IoT), and an edge. As a size of the deep neural network increases dramatically, various pieces of redundancy are present in the deep neural network. To solve this issue, various attempts have been made, such as pruning and quantization.

Most modern neural networks may use batch normalization layers. Some of the modern neural networks may use a pruning method of performing learning to add sparsity to a scale term of a batch normalization layer. In this case, an L1 loss is commonly used for sparsity regularization. When the L1 loss is used, scale terms of all of the batch normalizations are reduced with the same gradient. In the case of pruning, only the number of non-zero terms is important, and the size of the deep neural network is not affected. Accordingly, a sparsity regularization method better than an L1 regularization method is continuously studied.

### SUMMARY

Embodiments of the present disclosure provide adaptive regularization based on a target pruning ratio and a scale term of current batch normalization when learning is performed based on sparsity regularization in the lightweight of a deep neural network. In this way, it is possible to minimize a task loss of the lightweight of a deep neural network.

According to an embodiment, a deep neural network lightweight device based on batch normalization includes a memory that stores at least one data and at least one processor that executes a network lightweight module. When executing the network lightweight module, the processor performs learning on an input neural network based on sparsity regularization to adaptively determine at least one parameter of the sparsity regularization, performs pruning on the learning result, and performs fine tuning on the pruning result.

According to an embodiment, a deep neural network lightweight method based on batch normalization includes performing learning on an input neural network based on sparsity regularization, performing pruning on the learning result, and performing fine tuning on the pruning result. The performing of the learning based on the sparsity regularization includes adaptively determining at least one parameter of the sparsity regularization.

### BRIEF DESCRIPTION OF THE FIGURES

The above and other objects and features of the present disclosure will become apparent by describing in detail embodiments thereof with reference to the accompanying drawings.

FIG. 1 illustrates a block diagram of a deep neural network lightweight device, according to an embodiment of the present disclosure.

FIG. 2 illustrates a graph of TL1 regularization, according to an embodiment of the present disclosure.

FIG. 3 illustrates a flowchart of a deep neural network lightweight device, according to an embodiment of the present disclosure.

FIG. 4 illustrates a flowchart of a deep neural network lightweight device, according to an embodiment of the present disclosure.

FIG. 5 illustrates a flowchart of a deep neural network lightweight device, according to an embodiment of the present disclosure.

FIG. 6 illustrates a result graph of a deep neural network lightweight device, according to an embodiment of the present disclosure.

### DETAILED DESCRIPTION

Hereinafter, embodiments of the present disclosure will be described with reference to the accompanying drawings in detail and clearly to such an extent that an ordinary one in the art easily implements the present disclosure.

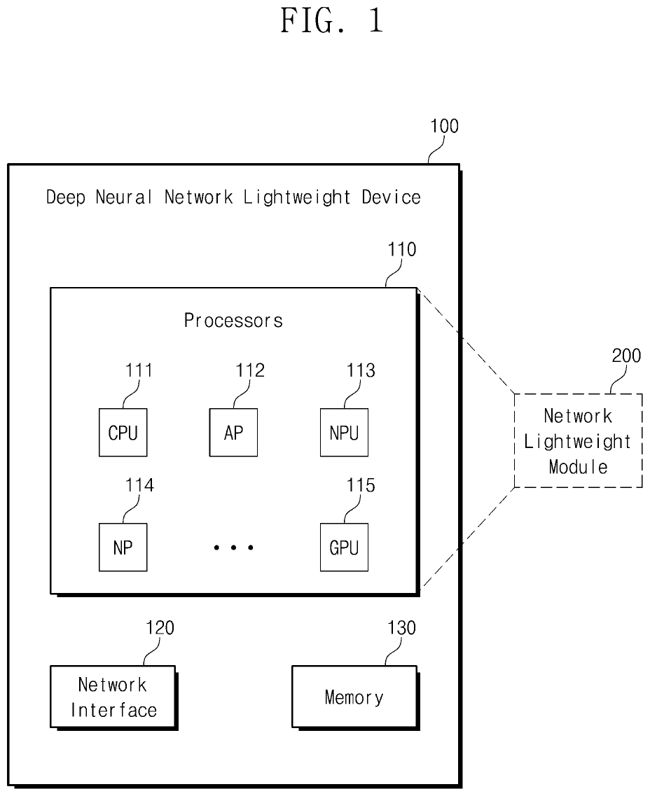

FIG. 1 illustrates a block diagram of a deep neural network lightweight device, according to an embodiment of the present disclosure. Referring to FIG. 1, a deep neural network lightweight device 100 may include processors 110, a network interface 120, a memory 130, and a network lightweight module 200.

The processors 110 may function as a central processing unit of the deep neural network lightweight device 100. At least one of the processors 110 may drive the network lightweight module 200. The processors 110 may include, for example, at least one general-purpose processor such as a central processing unit (CPU) 111 or an application processor (AP) 112. Moreover, the processors 110 may further include at least one special-purpose processor such as a neural processing unit (NPU) 113, a neuromorphic processor 114, or a graphics processing unit (GPU) 115. The processors 110 may include two or more homogeneous processors. As another example, at least one (or at least another) of the processors 110 may be manufactured to implement various machine learning or deep learning modules.

At least one of the processors 110 may be used to learn the network lightweight module 200. At least one of the processors 110 may learn the network lightweight module 200 based on various pieces of data or information.

At least one (or at least another) of the processors 110 may execute the network lightweight module 200. The network lightweight module 200 may perform network lightweight based on batch normalization by performing machine learning or deep learning. For example, at least one (or at least another one) of the processors 110 may perform learning on an input neural network based on sparsity regularization to adaptively determine at least one parameter of sparsity regularization, by executing the network lightweight module 200. Moreover, at least one (or at least another) of the processors 110 may execute the network lightweight module 200 to perform pruning on the learning result and to perform fine tuning on the pruning result.

The network lightweight module 200 may be implemented in a form of instructions (or codes) executed by at least one of the processors 110. In this case, the at least one processor may store instructions (or codes) of the network lightweight module 200 in the memory 130.

As another example, at least one (or at least another) of the processors 110 may be manufactured to implement the network lightweight module 200. For example, the at least one processor may be a dedicated processor implemented in hardware based on the network lightweight module 200 generated by the learning of the network lightweight module 200.

As another example, at least one (or at least another) of the processors 110 may be manufactured to implement various machine learning or deep learning modules. For example, at least one (or at least another) of the processors 110 may perform learning on an input neural network based on sparsity regularization. In this case, the sparsity regularization may be transformed L1 (TL1) regularization. At least one (or at least another) of the processors 110 may calculate a task loss and a regularization loss, may perform backpropagation based on the calculation result, and may perform deep learning based on the backpropagation result.

Moreover, the at least one processor may implement the network lightweight module 200 by receiving information (e.g., instructions or codes) corresponding to the network lightweight module 200.

The network interface 120 may provide remote communication with an external device. The network interface 120 may perform wireless or wired communication with the external device. The network interface 120 may communicate with the external device through at least one of various communication schemes such as Ethernet, wireless-fidelity (Wi-Fi), long term evolution (LTE), and 5th generation (5G) mobile communication. For example, the network interface 120 may communicate with an external device of the deep neural network lightweight device 100.

The network interface 120 may receive calculation data, which is to be processed by the deep neural network lightweight device 100, from the external device. The network interface 120 may output result data, which is generated by the deep neural network lightweight device 100, to the external device. For example, the network interface 120 may store the result data in the memory 130.

The memory 130 may store data and process codes, which are processed or to be processed by the processors 110. For example, in some embodiments, the memory 130 may store data to be entered into the deep neural network lightweight device 100 or pieces of data generated or learned in a process of performing a deep neural network by the processors 110.

The memory 130 may be used as a main memory device of the deep neural network lightweight device 100. The memory 130 may include a dynamic random access memory (DRAM), a static RAM (SRAM), a phase-change RAM (PRAM), a magnetic RAM (MRAM), a ferroelectric RAM (FeRAM), a resistive RAM (RRAM), or the like.

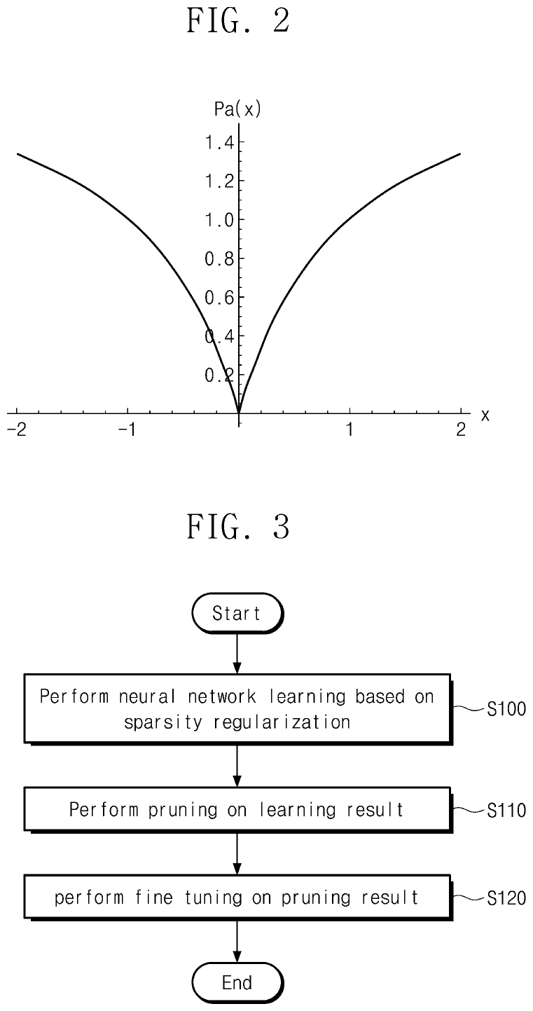

FIG. 2 illustrates a graph of TL1 regularization, according to an embodiment of the present disclosure. In this case, the TL1 regularization may be calculated based on Equation 1 as follows.

$${P}_{a} ( x ) = {\sum }_{i = 1}^{n} \frac{( a + 1 ) \vert {x}_{i} \vert}{a + \vert {x}_{i} \vert} \qquad [ Equation 1 ]$$

Referring to FIG. 2 and Equation 1, the TL1 regularization has one parameter ‘a’, and a gradient of a graph of the TL1 regularization may change depending on a value of parameter ‘a’. As the value of parameter ‘a’ approaches infinity, the TL1 regularization may converge to L1 regularization. As the value of parameter ‘a’ approaches 0, the TL1 regularization may converge to L0 regularization.

When the TL1 regularization is used as sparsity regularization, a graph shape of the TL1 regularization may vary depending on a scaling factor ‘γ’ of batch normalization. For example, when the scaling factor ‘γ’ is small, Pₐ(x) may quickly converge to ‘0’ due to a steep gradient. When the scaling factor ‘γ’ is great, Pₐ(x) may be more affected by a task loss due to a gentle gradient.

FIG. 3 illustrates a flowchart of a deep neural network lightweight device, according to an embodiment of the present disclosure. Referring to FIGS. 1 and 3, the deep neural network lightweight device 100 may perform operation S100 to operation S120.

In operation S100, under the control of the processors 110, the deep neural network lightweight device 100 may perform neural network learning based on sparsity regularization. For example, under the control of the processors 110, the deep neural network lightweight device 100 may perform neural network learning on an input neural network based on sparsity regularization.

In operation S110, the deep neural network lightweight device 100 may perform pruning under the control of the processors 110. For example, under the control of the processors 110, the deep neural network lightweight device 100 may remove channels as much as a predetermined target pruning ratio ‘p’ by performing pruning on the result of operation S100.

In operation S120, the deep neural network lightweight device 100 may perform fine tuning under the control of the processors 110. For example, under the control of the processors 110, the deep neural network lightweight device 100 may finely adjust parameters of a neural network by performing fine tuning on the result of operation S110. In this way, the deep neural network lightweight device 100 may restore the recognition ability of a neural network.

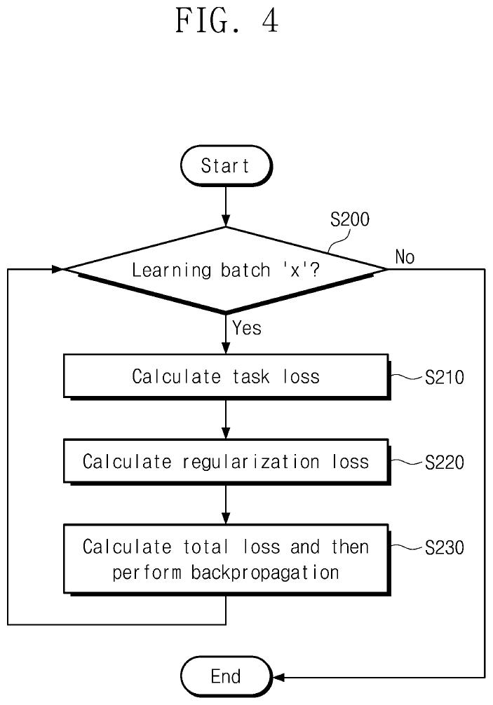

FIG. 4 illustrates a flowchart of a deep neural network lightweight device, according to an embodiment of the present disclosure. Referring to FIGS. 1, 3, and 4, the deep neural network lightweight device 100 may perform operation S200 to operation S230 in performing operation S100.

In operation S200, the deep neural network lightweight device 100 may determine whether learning batch ‘x’ is received for each learning loop, under the control of the processors 110. For example, under the control of the processors 110, the deep neural network lightweight device 100 may perform a learning process (e.g., operation S210 to operation S230) of a neural network based on sparsity regularization, in response to an event that the learning batch ‘x’ is received. The deep neural network lightweight device 100 may terminate the learning process of the neural network in response to an event that the learning batch ‘x’ is not received.

In operation S210, the deep neural network lightweight device 100 may calculate a task loss of the received learning batch ‘x’ under the control of the processors 110. For example, under the control of the processors 110, the deep neural network lightweight device 100 may calculate the task loss from the received learning batch ‘x’, a weight ‘W’, and the scaling factor ‘γ’ of the batch normalization. In this case, the task loss may be calculated based on Equation 2 as follows.

$$L ( x , W ) = {\sum }_{x , y} l ( f ( x , W ) , y ) \qquad [ Equation 2 ]$$

In operation S220, the deep neural network lightweight device 100 may calculate a regularization loss under the control of the processors 110. For example, under the control of the processors 110, the deep neural network lightweight device 100 may calculate the regularization loss from the scaling factor ‘γ’ of batch normalization. In this case, the regularization loss may be calculated based on Equation 3 as follows.

$${L}_{reg} ( γ ) = λ {\sum }_{γ} g ( γ ) \qquad [ Equation 3 ]$$

In this case, ‘λ’ may denote a coefficient of a sparsity regularization term, and g(γ) may denote a sparsity-induced penalty (e.g., g(γ)=|γ|) for a scaling factor.

In operation S230, the deep neural network lightweight device 100 may calculate the total loss and then may perform backpropagation, under the control of the processors 110. For example, under the control of the processors 110, the deep neural network lightweight device 100 may calculate the total loss based on the task loss and the regularization loss, which are respectively calculated in operation S210 and operation S220, and then may perform backpropagation. In this case, the total loss may be calculated by adding the task loss and the regularization loss.

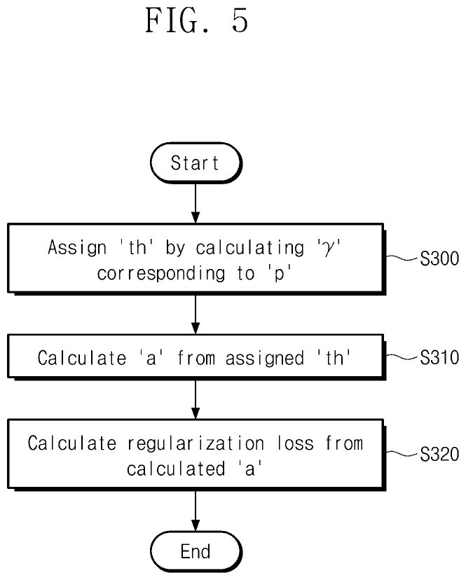

FIG. 5 illustrates a flowchart of a deep neural network lightweight device, according to an embodiment of the present disclosure. Referring to FIGS. 1 to 5, the deep neural network lightweight device 100 may perform operation S300 to operation S320 in performing operation S220.

In operation S300, the deep neural network lightweight device 100 may assign a parameter ‘th’ by calculating the scaling factor ‘γ’ corresponding to a target pruning ratio ‘p’ under the control of a processor. For example, under the control of the processor, the deep neural network lightweight device 100 may sort the entire scaling factor ‘γ’, may calculate a value corresponding to the target pruning ratio ‘p’ in the sorted scaling factor ‘γ’, and may assign the parameter ‘th’.

In operation S310, the deep neural network lightweight device 100 may calculate a parameter ‘a’ from the assigned parameter ‘th’ under the control of the processor. The parameter ‘a’ may be calculated based on Equation 4 as follows.

$${\frac{\partial {P}_{a} ( x )}{\partial x} ⌋}_{x = th} = 1 \qquad [ Equation 4 ]$$

In this case, a result of Equation 4 may be “a=2th+th²”.

In operation S320, the deep neural network lightweight device 100 may calculate a regularization loss from the calculated ‘a’ under the control of the processor. For example, under the control of the processor, the deep neural network lightweight device 100 may calculate the regularization loss from Pₐ(γ).

Through operation S300 to operation S320, the regularization loss may not be fixed, but may be determined adaptively. That is, the regularization loss may be adaptively determined by the target pruning ratio ‘p’ and the scaling factor ‘γ’ of current batch normalization.

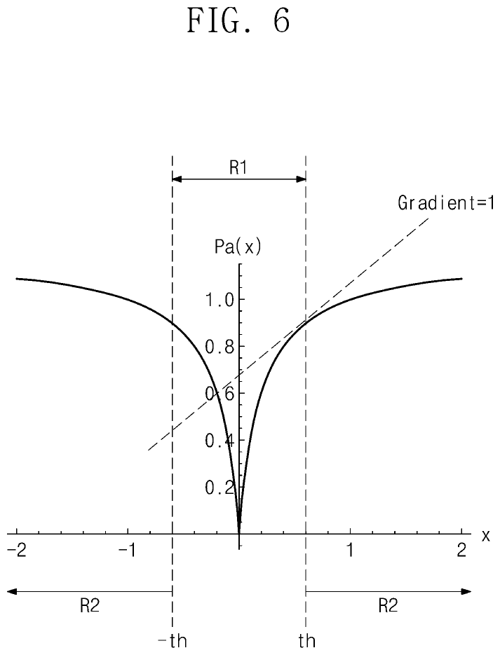

FIG. 6 illustrates a result graph of a deep neural network lightweight device, according to an embodiment of the present disclosure. In this case, FIG. 6 may be a result of Equation 4 with a graph. Referring to FIG. 6 and Equation 4, Pₐ(x) may be divided into a first region and a second region depending on a range of ‘x’. When ‘x’ is greater than the parameter ‘th’ with a boundary of the parameter ‘th’, a regularization gradient of a TL1 regularization graph may be less than that of L1 regularization. When ‘x’ is smaller than the parameter ‘th’ with the boundary of parameter ‘th’, the regularization gradient of the TL1 regularization graph may be greater than that of the L1 regularization.

The first region R1 means a case of “|γ|<th”. In this case, the scaling factor ‘γ’ corresponding to the target pruning ratio ‘p’ may quickly converge to ‘0’, and the total loss may be focused on sparsity regularization. The second region R2 means a case of “|γ|>th”. In this case, the total loss may be focused on the task loss.

The above description refers to embodiments for implementing the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

According to an embodiment of the present disclosure, sparsity regularization in a learning stage of a deep neural network may be adaptively adjusted depending on a target pruning ratio when a deep neural network lightweight device is used. Accordingly, the performance of a main task is improved. In addition, the performance may be prevented from degrading by minimizing a change in a network after pruning.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A deep neural network lightweight device based on batch normalization, the device comprising:
a memory configured to store at least one data; and
at least one processor configured to execute a network lightweight module,
wherein, when executing the network lightweight module, the processor is configured to:
perform learning on an input neural network based on sparsity regularization to adaptively determine at least one parameter of the sparsity regularization;
perform pruning on the learning result; and
perform fine tuning on the pruning result.

2. The device of claim 1, wherein the processor is configured to:
calculate a task loss and a regularization loss;
perform backpropagation based on the calculation result; and
perform the learning based on the backpropagation result.

3. The device of claim 2, wherein the sparsity regularization is transformed L1 (TL1) regularization, and
wherein the TL1 regularization is expressed as
$${P}_{a} ( x ) = {\sum }_{i = 1}^{n} \frac{( a + 1 ) \vert {x}_{i} \vert}{a + \vert {x}_{i} \vert} .$$

4. The device of claim 3, wherein the task loss is expressed as Σ_{x,y}I(f(x,W),y), and
wherein the regularization loss is expressed as λΣ_{γ}g(γ).

5. The device of claim 4, wherein the processor performs the learning by adaptively determining a parameter ‘a’.

6. The device of claim 5, wherein the processor determines the parameter ‘a’ based on a learning batch ‘x’, a scaling factor ‘γ’ of the batch normalization, and a target pruning ratio ‘p’.

7. A deep neural network lightweight method based on batch normalization, the method comprising:
performing learning on an input neural network based on sparsity regularization;
performing pruning on the learning result; and
performing fine tuning on the pruning result,
wherein the performing of the learning based on the sparsity regularization includes:
adaptively determining at least one parameter of the sparsity regularization.

8. The method of claim 7, wherein the performing of the learning based on the sparsity regularization includes:
calculating a task loss and a regularization loss; and
performing backpropagation after calculating a total loss from the calculated task loss and the calculated regularization loss.

9. The method of claim 8, wherein the sparsity regularization is transformed L1 (TL1) regularization, and
wherein the TL1 regularization is expressed as
$${P}_{a} ( x ) = {\sum }_{i = 1}^{n} \frac{( a + 1 ) \vert {x}_{i} \vert}{a + \vert {x}_{i} \vert} .$$

10. The method of claim 9, wherein the task loss is expressed as Σ_{x,y}I(f(x,W),y).

11. The method of claim 10, wherein the regularization loss is expressed as λΣ_{γ}g(γ).

12. The method of claim 11, wherein the adaptively determining of the at least one parameter of the sparsity regularization includes:
adaptively determining a parameter ‘a’.

13. The method of claim 12, wherein the adaptively determining of the parameter ‘a’ includes:
receiving a learning batch ‘x’, a scaling factor ‘γ’ of the batch normalization, and a target pruning ratio ‘p’;
sorting the scaling factor ‘γ’;
assigning a parameter ‘th’ by calculating a value corresponding to the target pruning ratio ‘p’ in the sorted scaling factor ‘γ’; and
calculating the parameter ‘a’ from the assigned parameter ‘th’.

14. The method of claim 13, wherein the calculating of the parameter ‘a’ from the assigned parameter ‘th’ satisfies a condition of
$${\frac{\partial {P}_{a} ( x )}{\partial x} ⌋}_{x = th} = 1.$$
